(19) United States
(12) Patent Application Publication
(10) Pub. No.: US 2009/0214770 A1
(43) Pub. Date: Aug. 27, 2009

(54) Conductive film formation during glass draw

(76) Inventors: Dilip Kumar Chatterjee, Rochester, NY (US); Curtis Robert Fekety, Tioga, PA (US); Clinton Damon Osterhout, Beaver Dams, NY (US); Zhen Song, Painted Post, NY (US); Carlton Maurice Truesdale, Corning, NY (US); Ji Wang, Painted Post, NY (US)

Correspondence Address: CORNING INCORPORATED, SP-TI-3-1, CORNING, NY, 14831, US

(21) Appl. No.: 12/070,846

(22) Filed: Feb. 21, 2008

(51) Int. Cl. B05D 5/06

(52) U.S. Cl. 427/168

(57) ABSTRACT

Methods for coating a glass substrate as it is being drawn, for example, during fusion draw or during fiber draw are described. The coatings are conductive metal oxide coatings which can also be transparent. The conductive thin film coated glass substrates can be used in, for example, display devices, solar cell applications and in many other rapidly growing industries and applications.

### BACKGROUND

1. Field of the Invention

Embodiments of the invention relate to methods for coating a substrate and more particularly to methods for coating a glass substrate with a conductive thin film during glass draw.

2. Technical Background

Transparent and electrically conductive thin film coated glass is useful for a number of applications, for example, in display applications such as the back plane architecture of display devices, for example, liquid crystal displays (LCD), organic light-emitting diodes (OLED) for cell phones. Transparent and electrically conductive thin film coated glass is also useful for solar cell applications, for example, as the transparent electrode for some types of solar cells and in many other rapidly growing industries and applications.

Conventional methods for coating glass substrates typically include vacuum pumping of materials, cleaning of glass surfaces prior to coating, heating of the glass substrate prior to coating and subsequent depositing of specific coating materials.

Typically, deposition of conductive transparent thin films on glass substrates is performed in a vacuum chamber either by sputtering or by chemical vapor deposition (CVD), for example, plasma enhanced chemical vapor deposition (PECVD).

Sputtering of conductive transparent thin films on glass, for example, sputter deposition of indium doped tin oxide on glasses, has one or more of the following disadvantages: large area sputtering is challenging, time consuming, and generally produces non-uniform films on glass substrates, especially glass substrates of increased size, for example, display glass for televisions.

The glass cleaning prior to coating in several conventional coating methods introduces complexity and additional cost. Also, several conventional coating methods require a doping of the coating which is typically difficult and introduces additional processing steps.

It would be advantageous to develop a method for coating a glass substrate with a transparent conductive thin film while increasing coating density and/or minimizing morphology variations evident in conventional coating methods while reducing manufacturing cost and manufacturing time.

### SUMMARY

Methods for coating a glass substrate with a conductive thin film as described herein, addresses one or more of the above-mentioned disadvantages of the conventional coating methods, in particular, when the coating comprises a metal oxide.

In one embodiment, a method for coating a glass substrate during glass draw is disclosed. The method comprises providing a solution comprising a metal halide and a solvent, preparing aerosol droplets of the solution, and applying the aerosol droplets to the glass substrate as it is being drawn.

Additional features and advantages of the invention will be set forth in the detailed description which follows, and in part will be readily apparent to those skilled in the art from the description or recognized by practicing the invention as described in the written description and claims hereof, as well as the appended drawings.

It is to be understood that both the foregoing general description and the following detailed description are merely exemplary of the invention, and are intended to provide an overview or framework to understanding the nature and character of the invention as it is claimed.

The accompanying drawings are included to provide a further understanding of the invention, and are incorporated in and constitute a part of this specification. The drawings illustrate one or more embodiment(s) of the invention and together with the description serve to explain the principles and operation of the invention.

### BRIEF DESCRIPTION OF THE DRAWINGS

The invention can be understood from the following detailed description either alone or together with the accompanying drawings.

FIG. 1 is a schematic of a system used to coat glass substrates in a method according to one embodiment.

FIG. 2a is a side view schematic of applying the aerosol droplets to a glass substrate as it is being drawn according to one embodiment.

FIG. 2b is a front view schematic of applying the aerosol droplets to a glass substrate as it is being drawn according to the embodiment shown in FIG. 2a.

FIG. 3 is a schematic of applying the aerosol droplets to a glass substrate as it is being drawn according to one embodiment.

FIG. 4 is a graph of transmittance for a conductive thin film coated glass substrate.

FIG. 5 is a top down view scanning electron micrograph (SEM) image of a conductive thin film coated glass substrate.

FIG. 6 is a cross sectional view SEM image of a conductive thin film coated glass substrate.

### DETAILED DESCRIPTION

Reference will now be made in detail to various embodiments of the invention, an example of which is illustrated in the accompanying drawings.

In one embodiment, a method for coating a glass substrate during glass draw is disclosed. The method comprises providing a solution comprising a metal halide and a solvent, preparing aerosol droplets of the solution, and applying the aerosol droplets to the glass substrate as it is being drawn.

According to one embodiment, the solvent comprises a material selected from water, an alcohol, a ketone and combinations thereof. In some embodiments, the solvent is selected from ethanol, acetone and combinations thereof. Other useful solvents are solvents in which the metal halide is soluble.

The aerosol droplets, according to one embodiment, are deposited on the glass substrate and the metal halide converts to its respective oxide upon application to the glass substrate. Pyrolysis reactions are possible when the solvent comprises water. In these reactions, the metal halide reacts with water and converts to its respective oxide. When the solvent comprises only alcohol, a flash reaction can occur in the presence of oxygen where the alcohol is evaporated and\or combusted. The metal halide reacts with the oxygen in an oxidation reaction to form its respective oxide.

In one embodiment, the oxide sinters to form a conductive film. The conductive film is transparent in some embodiments.

The metal halide can be selected from, for example, SnCl₄, SnBr₄, ZnCl₂ and combinations thereof. In one embodiment, the solution comprises the metal halide in an amount of from 5 to 10 weight percent of the solution, for example, 7 weight percent or more of the solution.

According to one embodiment, preparing aerosol droplets comprises atomizing the solution. Atomizing the solution, according to one embodiment, comprises flowing a gas selected from argon, helium, nitrogen, carbon monoxide, hydrogen in nitrogen and oxygen through the solution in an atomizer. According to another embodiment, atomizing the solution comprises flowing ambient air through the atomizer. In some embodiments, the velocity of the atomized solution can be between 2 liters per minute (L/min) and 7 L/min, for example, 3 L/min.

In one embodiment, the aerosol droplets have a mean droplet size of from 10 nanometers to 1000 nanometers in diameter, for example, a mean droplet size of from 50 nanometers to 150 nanometers.

Applying the aerosol droplets, in one embodiment, comprises spraying the aerosol droplets from a sprayer adapted to receive the aerosol droplets from the atomizer and located proximate to the glass substrate. The aerosol sprayer can be of any shape depending on the shape of the glass substrate to be coated and the area of the glass substrate to be coated. Spraying the aerosol droplets can comprise translating the sprayer in one or more directions relative to the glass substrate, for example, in an X direction, a Y direction, a Z direction or a combination thereof in a three dimensional Cartesian coordinate system.

The glass substrate can be selected from a glass fiber and a glass ribbon. Exemplary draw processes include draw-down glass forming (e.g. fusion draw, tube drawing, slot drawing and vertical draw. One embodiment of the invention comprises applying the aerosol droplets to a glass ribbon being drawn from an isopipe in a fusion draw process.

During the glass draw process, the nascent glass surface of the glass substrate is typically pristine and ideal for depositing aerosol droplets on the glass substrate and subsequently forming a conductive thin film, in part, due to the temperature of the glass substrate and due to the glass substrate being touched only by the equipment used during the glass draw process. Thus, cleaning the glass substrates prior to coating is not required.

According to one embodiment, applying the aerosol droplets comprises applying the aerosol droplets to the glass substrate that has reached or is below its glass transition temperature.

According to one embodiment, applying the aerosol droplets comprises applying the aerosol droplets to the glass substrate when the glass substrate is elastic.

According to one embodiment, the method comprises applying the aerosol droplets to the glass substrate that is at a temperature of from 295 degrees Celsius to 425 degrees Celsius, for example, at a temperature of from 345 degrees Celsius to 375 degrees Celsius as the glass substrate is being drawn.

Features 200 and 201 of a method of coating a glass substrate during the fusion draw process are shown in FIG. 2a and FIG. 2b. The temperature of the glass substrate 36, in this embodiment, glass ribbon, as it exits the isopipe 30 can be 1100° C. or more. The distance Y from the outlet of the isopipe 34 to the aerosol sprayer 32 can be adjusted so as to correspond to the desired temperature of the glass ribbon. The desired temperature of the glass ribbon can be determined by the temperature required to form the metal oxide upon deposition on the glass ribbon to form a conductive thin film coated glass substrate 38, in this example, conductive thin film coated glass ribbon. Similarly, the distance X from the aerosol sprayer to the glass ribbon can be adjusted so as to correspond with a desired velocity of the aerosol droplets.

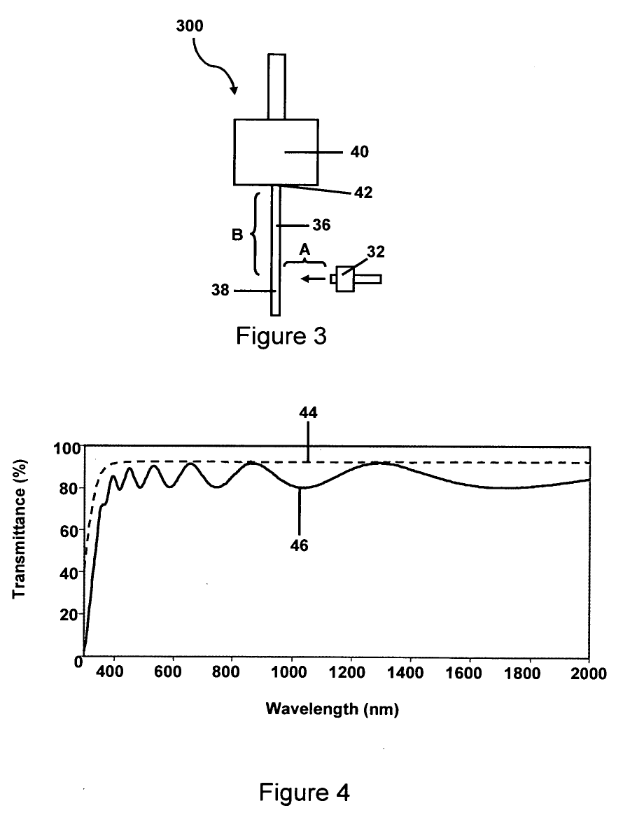

Feature 300 of a method of coating a glass substrate during the fiber draw process are shown in FIG. 3. The temperature of the glass substrate 36, in this embodiment, a glass fiber, as it exits the furnace 40 can be 1100° C. or more. The distance B from the outlet of the furnace 42 to the aerosol sprayer 32 can be adjusted so as to correspond to the desired temperature of the glass fiber. According to another embodiment, distance B can be the distance from a cooling unit (not shown) to the aerosol sprayer. The desired temperature of the glass fiber can be determined by the temperature required to form the metal oxide upon deposition on the glass fiber to form a conductive thin film coated glass substrate 38, in this example, conductive thin film coated glass fiber. Similarly, the distance A from the aerosol sprayer to the glass fiber can be adjusted so as to correspond with a desired velocity of the aerosol droplets.

Distances, X and Y in FIG. 2a and FIG. 2b, or A and B in FIG. 3, can be adjusted so as to deposit aerosol droplets as opposed to a dry powder onto the glass substrate. Using a substantially laminar flow as opposed to a turbulent flow of the aerosol droplets and deposition of aerosol droplets as opposed to a dry powder can result in a denser and/or a more continuous conductive thin film on the glass substrate.

### EXAMPLE 1

A solution was prepared comprising 3.5 grams of SnCl₄ dissolved in 50 milliliters of deionized water. The solution was mixed in a glovebox filled with nitrogen. Mixing the solution in the glovebox minimized fuming. The solution was atomized using a Model 9306 Six-Jet Spray Atomizer, available from TSI Incorporated, Shoreview, Minn.

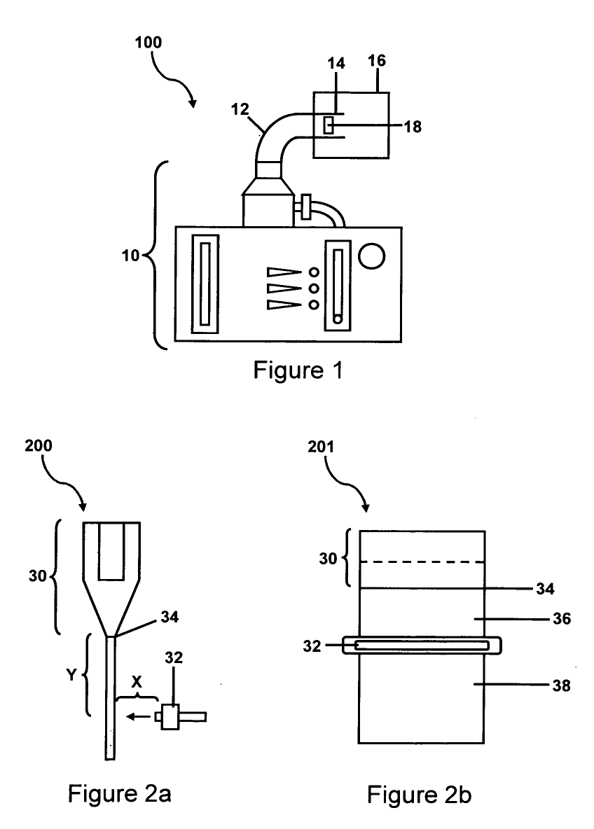

A schematic of a system used to coat glass substrates is shown in FIG. 1. The atomizer 10 was run with two of the six available jets open. Nitrogen gas flowing at 25 pounds per square inch (psi) was used as the atomizing gas for the solution and for the carrier gas for the aerosol droplets. The aerosol droplets were delivered to the glass substrates via a 1 inch outer diameter Tygon® tubing 12, available from Fisher Scientific, which was connected to a process tube 14 inside a Lindberg BlueM Model STF55346C tube furnace 16, also available from Fisher Scientific. In this example, the process tube was quartz. The furnace temperature was monitored independently by a J-type thermocouple placed just down-stream of the glass substrates.

Glass substrates, in this example, Eagle²⁰⁰⁰®, registered trademark of Corning Incorporated, slides, ¾ of an inch in width by 3 inches in length, were cleaned using ethanol-soaked wipes. The glass substrates 18 were placed in the center of the process tube 14. The process tube and the glass substrates were supported by an alumina refractory (not shown). One or more glass substrates can be coated in accordance with the disclosed method.

The process tube was heated to a set point temperature in the range of from 300° C. to 400° C. The actual temperature as measured by a J-type thermocouple placed underneath the glass substrates was about 25° C. higher than the set point temperature. The temperature as measured by the thermocouple during the coating process was 20° C. below the set point temperature, in part, due to evaporative cooling effects during the coating process.

Each glass substrate was coated using the aerosol droplets. Complete atomizing of the solution took approximately 30 minutes. After the solution was atomized, and the aerosol droplets were deposited onto the glass substrates, the glass substrates were held at temperature for an additional 30 minutes.

The aerosol droplets were deposited on the glass substrates and the metal halide, in this example, SnCl₄ converted to its respective oxide, in this example tin oxide, upon application to the glass substrate. The tin oxide sintered to form a conductive film, in this example, a conductive tin oxide film on the glass substrates. The glass substrates were then removed from the process tube and cooled to room temperature in air under ambient conditions.

Table 1 shows resistivity data for tin oxide thin film coated glass substrates produced according to the methods described in Example 1. The resistivity data is in Ohms per square. Electrical conductivity is the reciprocal of the electrical resistivity.

TABLE 1

| | Temperature | Ohms/Square | | |
|---|---|---|---|---|
| Glass Substrate | (Degrees Celsius) | Top | Center | Bottom |
| 1 | 300 | 862 | 1101 | 888 |
| 2 | 300 | 824 | 749 | 815 |
| 3 | 350 | 67 | 56 | 64.8 |
| 4 | 400 | 244 | 331 | 343 |

FIG. 4 is a graph of transmittance versus wavelength data for tin oxide coatings on glass substrates that were coated according to the methods described in Example 1 and when the glass substrates were heated to approximately 220° C. and approximately 300° C., 44 and 46 respectively. The tin oxide coating 44 was found to be amorphous and the tin oxide coating 46 was found to be crystalline (cassiterite). The oscillation in 46 is due to an interference phenomena dependent upon the crystalline layer thickness.

For the tin oxide coating coated at approximately 220° C., there was little conductivity of the tin oxide coating and the tin oxide coating poorly adhered to the glass substrates. Additionally, the tin oxide coating was found to be amorphous.

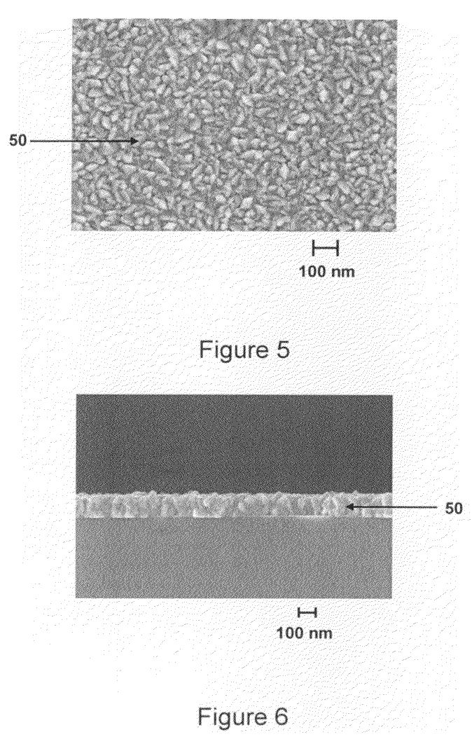

As shown in FIGS. 5 and 6, the tin oxide coating 50 coated at approximately 300° C. was found to form a dense and continuous film on the glass substrate.

### EXAMPLE 2

A solution was prepared comprising 3.5 grams of SnCl₄ dissolved in 50 milliliters of ethanol. The solution was mixed in a glovebox filled with nitrogen. Mixing the solution in the glovebox minimized fuming. The solution was atomized using a Model 9306 Six-Jet Spray Atomizer, available from TSI Incorporated, Shoreview, Minn.

The system and method described in Example 1 were used to coat glass substrates. The aerosol droplets were deposited on the glass substrates and the metal halide, in this example, SnCl₄ converted to its respective oxide, in this example tin oxide, upon application to the glass substrate. The tin oxide sintered to form a conductive film, in this example, a conductive tin oxide film on the glass substrates. The glass substrates were then removed from the process tube and cooled to room temperature in air under ambient conditions. The conductive tin oxide was transparent.

The elevated temperature of the glass substrates in the examples described above illustrates the elevated temperatures realized during a glass draw process. The elevated temperatures of the glass substrates can be seen in, for example, the fusion draw process for display glass and also the draw process for fiber.

The methods for coating a glass substrate during glass draw as described herein have one or more of the following advantages: cleanness of the nascent glass surface eliminates additional process steps of cleaning the glass substrate before film deposition; expensive vacuum systems and complex processing equipment is not needed; the coating is performed under ambient conditions; and doping/alloying of the coating species is relatively easy as compared to conventional coating methods. Also, film formation can be done continuously during glass draw as opposed to on individual already formed glass substrates.

Further, the deposition of low temperature evaporating metallic species such as Sn and Zn (instead of its high temperature oxides such as SnO2 and ZnO) and subsequent conversion of the metallic oxide by partial sintering and thermal treatment of the film is advantageous, in part, since the conversion to a metal oxide from a metal halide can occur at a considerably lower temperature, for example, approximately 300° C. for Sn (as opposed to, for example >1900° C. for SnO₂).

It will be apparent to those skilled in the art that various modifications and variations can be made to the present invention without departing from the spirit or scope of the invention. Thus, it is intended that the present invention cover the modifications and variations of this invention provided they come within the scope of the appended claims and their equivalents.

What is claimed is:

1. A method for coating a glass substrate during glass draw, the method comprising:
providing a solution comprising a metal halide and a solvent;
preparing aerosol droplets of the solution; and
applying the aerosol droplets to the glass substrate as it is being drawn.

2. The method according to claim 1, wherein the solvent comprises a material selected from water, an alcohol, a ketone and combinations thereof.

3. The method according to claim 2, wherein the solvent is selected from ethanol, acetone and combinations thereof.

4. The method according to claim 1, wherein the aerosol droplets are deposited on the glass substrate and the metal halide converts to its respective oxide upon application to the glass substrate.

5. The method according to claim 4, wherein the oxide sinters to form a conductive film.

6. The method according to claim 5, wherein the conductive film is transparent.

7. The method according to claim 1, wherein the metal halide is selected from SnCl₄, SnBr₄, ZnCl₂ and combinations thereof.

8. The method according to claim 1, wherein the solution comprises the metal halide in an amount of from 5 to 10 weight percent of the solution.

9. The method according to claim 1, wherein the solution comprises the metal halide in an amount of 7 weight percent or more of the solution.

10. The method according to claim 1, wherein the aerosol droplets have a mean droplet size of from 10 nanometers to 1000 nanometers in diameter.

11. The method according to claim 10, wherein the aerosol droplets have a mean droplet size of from 50 nanometers to 150 nanometers.

12. The method according to claim 1, wherein preparing aerosol droplets comprises atomizing the solution.

13. The method according to claim 12, wherein applying the aerosol droplets comprises spraying the aerosol droplets from a sprayer adapted to receive the aerosol droplets from the atomizer and located proximate to the glass substrate.

14. The method according to claim 13, further comprising translating the sprayer in one or more directions relative to the glass substrate.

15. The method according to claim 12, wherein atomizing the solution comprises flowing a gas selected from argon, helium, nitrogen, carbon monoxide, hydrogen in nitrogen and oxygen through the atomizer.

16. The method according to claim 1, wherein the glass substrate is selected from a glass fiber and a glass ribbon.

17. The method according to claim 1, which comprises applying the aerosol droplets to the glass substrate that has reached or is below its glass transition temperature.

18. The method according to claim 1, which comprises applying the aerosol droplets to the glass substrate when the glass substrate is elastic.

19. The method according to claim 1, which comprises applying the aerosol droplets to the glass substrate that is at a temperature of from 295 degrees Celsius to 425 degrees Celsius.

20. The method according to claim 19, which comprises applying the aerosol droplets to the glass substrate that is at a temperature of from 345 degrees Celsius to 375 degrees Celsius.
